(19) United States
(12) Patent Application Publication
(10) Pub. No.: US 2026/0118896 A1
(43) Pub. Date: Apr. 30, 2026

(54) No Power-Off Voltage Regulator for Small-Scale Low-Voltage Systems

(71) Applicant: Google LLC, Mountain View, CA (US)

(72) Inventors: Tong Zhang, Sunnyvale, CA (US); Sanjeev Suresh, Campbell, CA (US); Druthi Umapathy, Santa Clara, CA (US); Martin Johannes Kraemer, Mountain View, CA (US); James Christian Salvia, Belmont, CA (US)

(73) Assignee: Google LLC, Mountain View, CA (US)

(21) Appl. No.: 19/003,222

(22) Filed: Dec. 27, 2024

Related U.S. Application Data
(60) Provisional application No. 63/738,915, filed on Dec. 26, 2024.

(51) Int. Cl. G05F 1/575

(52) U.S. Cl. CPC G05F 1/575

(57) ABSTRACT

This document describes systems and techniques for a no power-off voltage regulator for small-scale low-voltage system. Specifically, the systems and techniques described include a single output transistor configured to supply power to core circuitry, in an active state, at an operating voltage within a safe operating range for core circuitry in an active state and, in a low-power state, at a low voltage below the operating voltage without shutting down the single output transistor. An amplifier is configured to selectively supply a bias voltage to the single output transistor effective to cause the single output transistor to supply the operating voltage when the single output transistor is in the active state and to supply the low power voltage when the single output transistor is in the low-power state.

### CROSS-REFERENCE TO RELATED APPLICATION(S)

This application claims the benefit of U.S. Provisional Patent Application Ser. No. 63/738,915 filed on Dec. 26, 2024, the disclosure of which is incorporated by reference herein in its entirety.

### SUMMARY

This document describes systems and techniques for a regulator circuit for use with core circuitry in integrated circuits, such as small-scale core circuitry in the two-nanometer range. Specifically, the systems and techniques described include a regulator circuit to supply power with an operating voltage within a safe operating range of the core circuitry in an active state and to supply a low voltage output in a low-power state without powering off the single output transistor.

For example, a regulator circuit apparatus includes a single output transistor configured to supply power to core circuitry, in an active state, at an operating voltage within a safe operating range for core circuitry in an active state and, in a low-power state, at a low voltage below the operating voltage without shutting down the single output transistor. An amplifier is configured to selectively supply a bias voltage to the single output transistor effective to cause the single output transistor to supply the operating voltage when the single output transistor is in the active state and to supply the low power voltage when the single output transistor is in the low-power state. Additional circuitry may be used to provide current to the amplifier without exposing the core circuitry to voltages outside of the safe operating range, to isolate the regulator circuit to prevent current leakage when the regulator circuit is not in the active state, and to provide a precision voltage source as a reference voltage for the amplifier.

This Summary is provided to introduce systems and techniques for a no power-off voltage regulator for small-scale low-voltage system, as further described below in the Detailed Description and Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of systems and techniques for a no power-off voltage regulator for small-scale low-voltage system are described in this document with reference to the following Drawings. The same numbers are used throughout the drawings to reference like features and components.

FIG. 1 is a schematic diagram of a regulator circuit configured to supply power to core circuitry in an active state and to supply a low voltage output in a low-power state;

FIG. 2 is a schematic diagram of a current source for use with the regulator circuit of FIG. 1;

FIG. 3 is a schematic diagram of a reference voltage circuit for use by an amplifier included in the regulator circuit of FIG. 1;

FIG. 4 is a schematic diagram of a regulator coupled with switching circuitry to isolate the regulator circuit when not in a low-power state to prevent current leakage;

FIGS. 5A and 5B are schematic diagrams of the regulator circuit of FIG. 1 incorporating middle compensation and operating in active and low-power states, respectively;

FIG. 6 is a schematic diagram of a circuit including multiple instances of the regulator circuit of FIG. 1; and

FIG. 7 is a timing diagram of signals when using the regulator circuit of FIG. 1.

### DETAILED DESCRIPTION

### Overview

Advanced integrated circuits, such as microprocessors or system-on-chip (SoC) devices offer greater computing capabilities in increasingly more-compact devices as gate-all-around and other more-compact transistor designs are implemented using two-nanometer technology and below. Reducing the scale of microprocessors and SoCs offers advantages in performance, reduced size, and reduced power consumption. However, interfacing these small-scale devices with external devices and signals presents a challenge. For example, supply voltages at levels that are suitable for larger-form microprocessors or SoCs may exceed the safe operating range of core circuitry in devices using gate-all-around technology or other small-scale technologies. Application of voltages outside of the safe operating range can degrade or damage such minuscule devices.

Regulator circuits may be incorporated in these devices to scale available, externally-supplied voltages to a reduced, safe core voltage level “V_{SAFE}” within the safe operating range that is usable to operate small-scale core circuitry. However, to provide an on-device regulator circuit that can produce V_{SAFE} may require multiple output transistors arranged in a cascode structure. Stacking transistors in a cascode structure consumes considerable space on the device. The cascode structure thus at least partially wastes some of the valuable space on the device.

Moreover, on-device regulator circuits also should be switchable to save power when the regulator devices are not actively powering core circuitry. However, to power off these regulator circuits may require power-down circuits that employ multiple transistors to shut down the regulator devices to prevent current leakage. Powering off these regulator circuits also may result in transient voltage spikes that may exceed the safe operating range of the core circuitry. These power-down circuits, like the cascode structure, may consume valuable space on the device. Moreover, conventional power-down circuits may require intermediate voltage sources that produce voltages at multiple levels to safely shut down the regulator circuits. Creating intermediate voltage supplies on the device would consume further on-device space. Even if the intermediate voltages are available external to the device, additional contacts or bumps must be provided to receive the intermediate voltages which may present a problem when package or contact space may be at a premium.

According to implementations described herein, instead of incorporating output transistors with multiple transistors, power-down circuits, and/or intermediate power supplies, a regulator circuit is implemented with a single output transistor that provides V_{SAFE} to power core circuitry when the regulator is in an active state and, when the core circuitry is not in use, the regulator transitions to a low voltage state in which the regulator produces a low, non-zero voltage output instead of being powered down. As a result, the regulator can be transitioned between the low voltage state and the active state without power-down circuitry and intermediate voltage sources and without transient voltage spikes to protect the core circuitry or current leakage and avoid wasting power.

In aspects, a regulator circuit apparatus includes a single output transistor configured to supply power to core circuitry, in an active state, at an operating voltage within a safe operating range for core circuitry in an active state and, in a low-power state, at a low voltage below the operating voltage without shutting down the single output transistor. An amplifier is configured to selectively supply a bias voltage to the single output transistor effective to cause the single output transistor to supply the operating voltage when the single output transistor is in the active state and to supply the low power voltage when the single output transistor is in the low-power state.

### Example Regulator Circuit

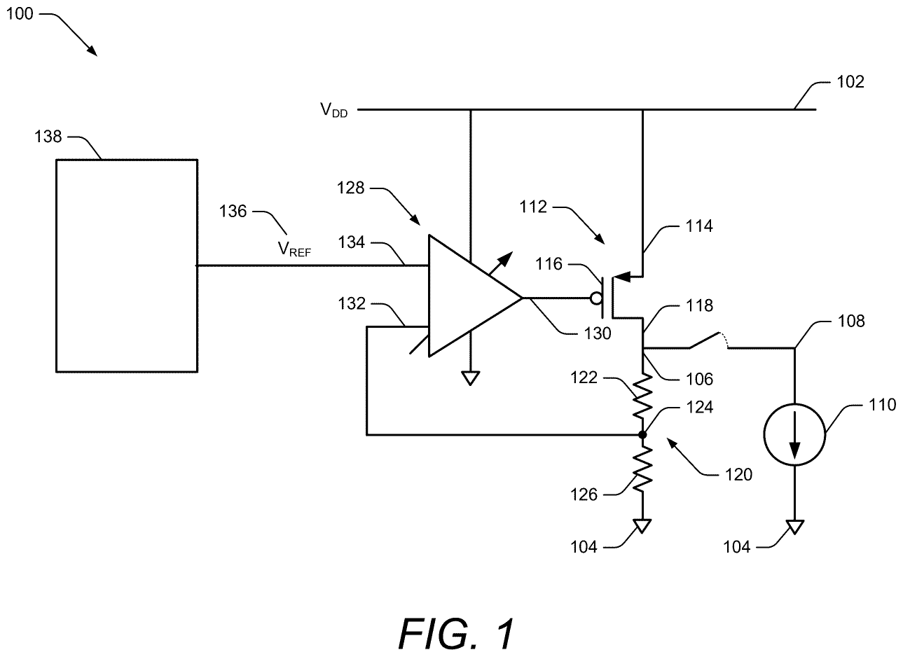

FIG. 1 depicts a regulator circuit 100 that receives a supply voltage V_{DD} 102 relative to a ground voltage or V_{SS} 104 and provides an ungated output 106 and a gated output 108 at an operating voltage suitable to power a load that includes core circuitry 110. The regulator circuit 100 is a low dropout (LDO) regulator and, thus, can operate at a low potential difference between the supply voltage V_{DD} 102 and V_{SS} 104. The core circuitry 110 may include small-scale circuitry down to the two-nanometer range and below. In an active state, the regulator circuit 100 provides power at V_{SAFE}, a voltage level less than V_{DD} 102, to avoid damage or degradation of devices included in the core circuitry. When the core circuitry 110 is not powered, the regulator circuit 100 transitions to a low-power state in which the regulator circuit provides a non-zero, low-voltage output. The low-voltage output is at a level less than that of V_{SAFE} and at a level that results in significantly reduced power consumption while avoiding the need for additional, space-consuming circuitry that would be needed to power down the regulator device 100. In addition, by switching the regulator circuit 100 between the active state and the low-power state, rather than by powering on and off the regulator circuit 100, power can be saved without the voltage instabilities that may result from powering the regulator circuit 100 off and on. These voltage instabilities between power-up and power-down states may result in transient voltages outside of the safe operating range of the core circuitry in the core circuitry 110, resulting in damage or degradation of those devices.

The regulator circuit 100 includes a single output transistor 112. In aspects, the single output transistor is a PMOS transistor that may take the place of a cascode structure incorporating multiple transistors that may be used in a regulator that is switched between being powered on and fully powered off. The output transistor 112 includes a source 114 coupled to V_{DD} 102, a gate 116, and a drain 118 that is coupled to the gated output 106 and the ungated output 108. The gated output 106 may be coupled to a voltage divider 120 including a first resistor 122 coupled at a node 124 to a second transistor 126 that is coupled to V_{SS} 104.

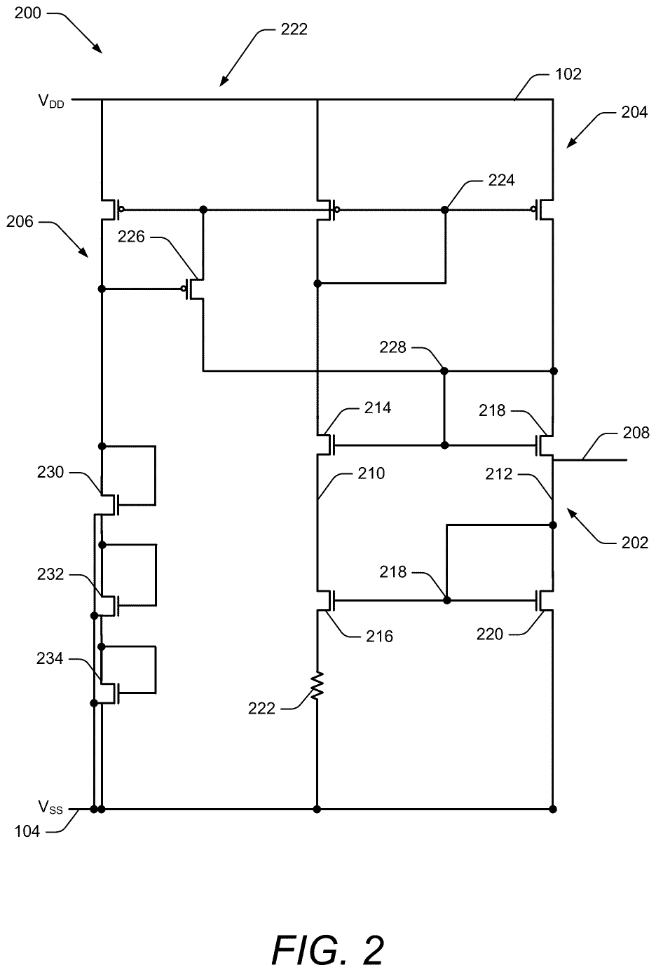

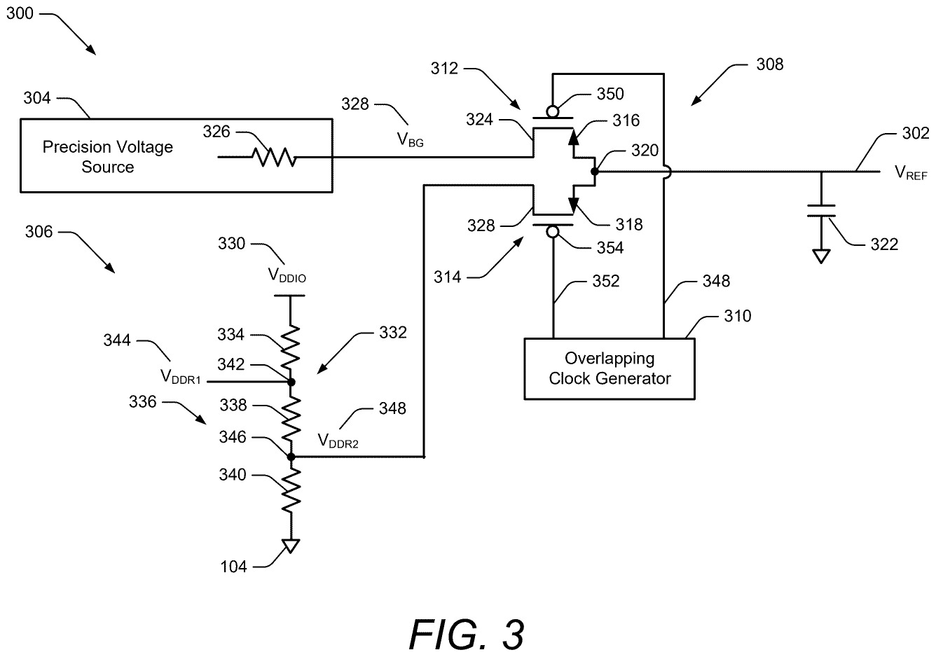

The gate 116 of the output transistor 112 is biased by an amplifier 128. As further described below, an output 130 of the amplifier 128 is adjusted to bias the gate 116 of the output transistor 112 to switch the outputs 106 and 108 of the single output transistor 112 between V_{SAFE}, a safe voltage level for the core circuitry of the core circuitry 110, and a low-voltage output at which the regulator circuit 100 rests when the regulator circuit 100 does not provide power to the core circuitry 110. The amplifier 128 is coupled to V_{DD} 102 and V_{SS} 104. In aspects, a first input 132 of the amplifier 128 is coupled to the node 124 of the voltage divider 120. The resistance values of the resistors 122 and 126 may be chosen to provide a desired voltage to the first input 132. The second input 134 is configured to receive an input current from a startup circuit 138 at a reference voltage V_{REF} 136, as further described below with reference to FIG. 2. In operation, generally, the regulator circuit 100 may provide its own reference voltage. However, in aspects, an external source of V_{REF} 136 is provided for initialization of the regulator circuit 100 as the regulator circuit 100 powers up and/or transitions from a low-power state to an active state. An apparatus for providing a source of V_{REF} 136 is explained below with reference to FIG. 3.

In operation, when the regulator circuit 100 is in an active state to power the core circuitry 110, the amplifier 128 is driven to bias the gate 116 of the output transistor 112 to provide the ungated output 106 and the gated output 108 at the desired supply voltage of the core circuitry 110, V_{SAFE}. In this active state, the amplifier 128 provides sufficient current to support operation of the core circuitry 110. When the regulator circuit 100 is not in an active state to power the core circuitry 110, the regulator circuit 100 transitions to the low-power state in which the amplifier 128 biases the gate 116 of the output transistor 112 so that the ungated output 106 produces a low voltage output. In aspects, the low voltage output is approximately equal to the reference voltage V_{REF} 136. The resulting current across the voltage divider 120 is very low to save power. Accordingly, when the regulator circuit 100 does not power the core circuitry 110, the regulator circuit 100 consumes a very small quantity of power without the additional circuitry, complexity, and/or intermediate power supplies that might be needed to actually power off the regulator circuit 100.

### Examples of Supporting Circuitry for the Regulator

As previously mentioned, the startup circuit 138 is configured to provide current to the amplifier 128. Conventionally, a constant transconductance (Gm) circuit may be used as a current source. However, initializing conventional constant Gm circuits may include switches or inverter-based startup circuits that may cause one or more of the transistors in the constant Gm circuit to operate, at least temporarily, outside of the safe operating range of core circuitry included in the core circuitry 110, potentially resulting in damage to or degeneration of one or more elements of the core circuitry in the core circuitry 110. Accordingly, the startup circuit 138 is configured to switchably provide current to the amplifier 128 without operating outside of the safe operating range.

FIG. 2 is a schematic of a current source circuit 200 that may be used to provide current to the amplifier 128 when the regulator circuit 100 is in an active state to power the core circuitry 110 (see FIG. 1). The current source circuit 200 includes three principle aspects including a current mirror 202, a current startup circuit 204, and a biasing circuit 206. The current mirror 202 provides an output 208 that is coupled to the second input 134 of the amplifier 128 to provide current to the amplifier 128 to bias the amplifier 128 and to power the core circuitry 110 when the regulator circuit 100 is in an active state to power the core circuitry 110.

Coupled between V_{DD} 102 and V_{SS} 104, the current mirror 202 would eventually reach a stable operating state with equal currents running through a first branch 210 and a second branch 212 of the current mirror 202. The current mirror 202 includes a first pair of NMOS transistors 214 and 216 in the first branch 210 that is mirrored with a second pair of NMOS transistors 218 and 220 in the second branch 212. As understood by those ordinarily skilled in the art, the current mirror 202 may be regarded as a bistable circuit that supports two operating states. In a first operating state, no current flows in the branches 208 and 214. In a second operating state, which is the stable operating state previously referenced, an operating current flows in both the first branch 208 and the second branch 214, flowing across the resistor 222 to the output 208 that is received at the amplifier 128.

However, in conventional current mirrors, before reaching this stable operating state, voltages in the current source circuit 200 may exceed the safe operating range of the core circuitry in the core circuitry 110, resulting in possible damage to elements of the core circuitry in the core circuitry 110. The current startup circuit 204 and the bias circuit 206 are used to manage the current mirror 202 to cause the current mirror 202 to reach the stable operating state quickly to avoid or minimize the current source circuit 200 operating outside of the safe operating range. Conventional circuitry to drive the current mirror 202 into the stable condition may include “kickstart” circuitry or inverter-based circuits to drive the current mirror 202 into the stable operating condition, but these implementations may result in one or more elements of the circuitry exceeding the safe operating range and, thus, exposing the core circuitry in the core circuitry 110 to damage or degradation.

Upon startup, a voltage at a bias node 224 may initially be “stuck” close to V_{DD} 102. The voltage being stuck at this level presents a danger to other circuitry because V_{DD} 102 exceeds the safe operating range of the core circuitry 110 or other circuitry. To initialize the current mirror and avoid voltage levels persisting outside the safe operating range, a startup transistor 226 in the current startup circuit 204 is enabled in response to the high voltage at the bias node 224. With the startup transistor 226 enabled, the startup transistor 226 directs supplemental current to a supply node 228 coupled to the current mirror 202, causing current to flow in the branches 210 and 212 of the current mirror 202 to drive the current mirror 202 into the stable operating condition.

Once current flows in the branches 210 and 212 of the current mirror 202 and the current mirror 202 reaches the stable operating condition, the voltage at the bias node 224 decreases. When the voltage level at the bias node 224 drops below the threshold voltage of the startup transistor 226, the startup transistor 226 is disabled and no longer directs the supplemental current to the supply node 228. Thus, the current startup circuit 206 becomes inactive and does not affect the ongoing operation of the current mirror 202 once the current mirror 202 reaches the stable operating condition with current flowing through the branches 210 and 212.

The biasing circuit 206 includes multiple transistors 230, 232, and 234 which, in this case, includes NMOS transistors. The transistors 230, 232, and 234 are coupled in a diode configuration. The transistors 230, 232, and 234 are configured to bias the startup transistor 226 so that, when the voltage at the bias node 224 is sufficiently high, a gate 236 of the startup transistor 226 is enabled to cause current to be directed to the node 228 to direct supplemental current to flow to the supply node 228 to cause current in the branches 210 and 212 to stabilize the current mirror 202 in the stable operating condition. At the same time, the transistors 230, 232, and 234 are configured so that, once the current mirror 202 has reached the stable operating condition, the gate 236 of the startup transistor 226 is disabled and, thus, no longer directs the supplemental current to the supply node 228.

As also previously stated, an external source of V_{REF} 136 may be required to provide V_{REF} 136 while the regulator circuit 100 (see FIG. 1) is in startup or transition. FIG. 3 shows a voltage source 300 configured to provide a V_{REF} source 302 external to the regulator circuit 100. The voltage source 300 is configured to provide voltage from a precision voltage source 304 when the regulator circuit 100 is in a stable, active state and to provide voltage from an always-on source 306 when the regulator circuit 100 is initializing or is transitioning from a low-power state to the active state. The always-on source 306 may be subject to appreciable output variations and, thus, not be as desirable to use as the precision voltage source 304. Nonetheless, the always-on source 306 provides a voltage source that is an approximation of V_{REF} when the precision voltage source 304 is stabilizing that is useful during initialization or transition from the low-power state to the active state.

It is acknowledged that including the always-on branch 306 superficially seems to contrast with the regulator circuit 100 transitioning from an active state to a low-power state to save power. However, in contrast to the regulator circuit 100, which may provide significant current to the core circuitry 110 in an active state, the always-on branch 306 does not power a load. Thus, although the always-on source 306 remains on at all times, the always-on source 306 draws a small current in the milliamp range. Thus, the always-on source 306 does not draw or source significant current that would significantly detract from power savings provided by switching the regulator circuit 100 to the low-power state when the regulator circuit 100 is not powering the core circuitry 110.

The precision voltage source reference 304 and the always-on source 306 are coupled to a multiplexer circuit 308 that is switched by an overlapping clock generator 310. The multiplexer circuit 308 includes a first transistor 312 and a second transistor 314. A source 316 of the first transistor 312 is coupled to a source 318 of the second transistor 314 at a node 320 to present the V_{REF} source 302.

A drain 324 of the first transistor 312 is coupled to the precision voltage source 304 that generates a current across a resistor 326 to provide a bandgap voltage 328. A drain 328 of the second transistor 314 is coupled to the always-on source 306. The always-on source 306 receives V_{DDIO} 330 at a first voltage divider 332. The first voltage divider 332 includes a first resistor 334 and a second voltage divider 336 that includes a second resistor 338 and a third resistor 340. A first node 342 of the first voltage divider 332 provides a source of V_{DDR1} 344 and a second node 346 of the second voltage divider 336 provides a source of V_{DDR2} 348 that is provided to the drain 328 of the second transistor 314. The resistance values of the resistors 334, 338, and 340 are selected to provide desired output voltages at the nodes 342 and 346 so that, for example, V_{DDR2} 348 at least approximates a desired value of V_{REF}. The resistance values of the resistors 334, 338, and 340 also are selected with high resistance values so as to minimize the current drawn by the always-on branch to reduce power consumption.

As previously mentioned, the multiplexer circuit 308 is switched by the overlapping clock generator 310. A first output 348 of the overlapping clock generator 310 may be coupled to a gate 350 of the first transistor and a second output 352 of the overlapping clock generator 310 may be coupled to a gate 354 of the second transistor 314. As a result, when the overlapping clock generator 310 switches states, the second transistor 314 will couple the always-on source 306 to the node 320 and/or the first transistor 312 will couple the precision voltage source 304 to the node 320.

An overlapping clock generator 310 is used because it is important that the amplifier 128 continually receives V_{REF} to be able to bias the output transistor 112. Non-overlapping clock generators are conventionally used to control multiplexers to avoid short-circuiting that may result when two voltages are applied to the same node, as might be applied by the sources 316 and 318 of the first and second transistors 312 and 314 at the node 320. However, if a non-overlapping clock generator is used, the voltage at V_{REF} source 302 may drop to zero, which would destabilize the operation of the regulator circuit 100. In aspects, the overlapping clock generator 310 is used to allow for slight overlap of the voltages applied at the node 320. The inclusion of the resistors 326, 334, 338, and 340 in branches coupled with the transistors 312 and 314 resists back-flowing currents and reduces risks that may arise from both voltages being applied at the node 320. The node 320 is coupled to a capacitor 322, which may have a low capacitance, to stabilize the voltage presented at the V_{REF} source 302.

In operation, when the regulator circuit 100 transitions from a low-power state to the active state, the amplifier 128 will initially be presented with V_{REF} from the always-on source 306 at the V_{REF} source 302. The multiplexer circuit 308 will then switch to present the output of the precision voltage source 304 at the V_{REF} source 302, then allow the regulator circuit 100 to settle in response to differences between the output of the always-on source 306 and the precision voltage source 304. When switching from the active state to the low-power state, the multiplexer circuit 308 switches to present V_{REF} from the always-on source 306 until the regulator circuit 100 is again switched into the active state.

As previously described with reference to FIG. 1, the regulator circuit 100 is not powered off when the core circuitry 110 it powers is not in use and powered on when the core circuitry 110 is in use, but instead transitions between a low-power state and an active state. While the regulator circuit 100 is in transition, the core circuitry 110 may be selectively decoupled from an output of the output transistor 114 to isolate the regulator circuit 100 from the rest of the circuit to prevent current leakage.

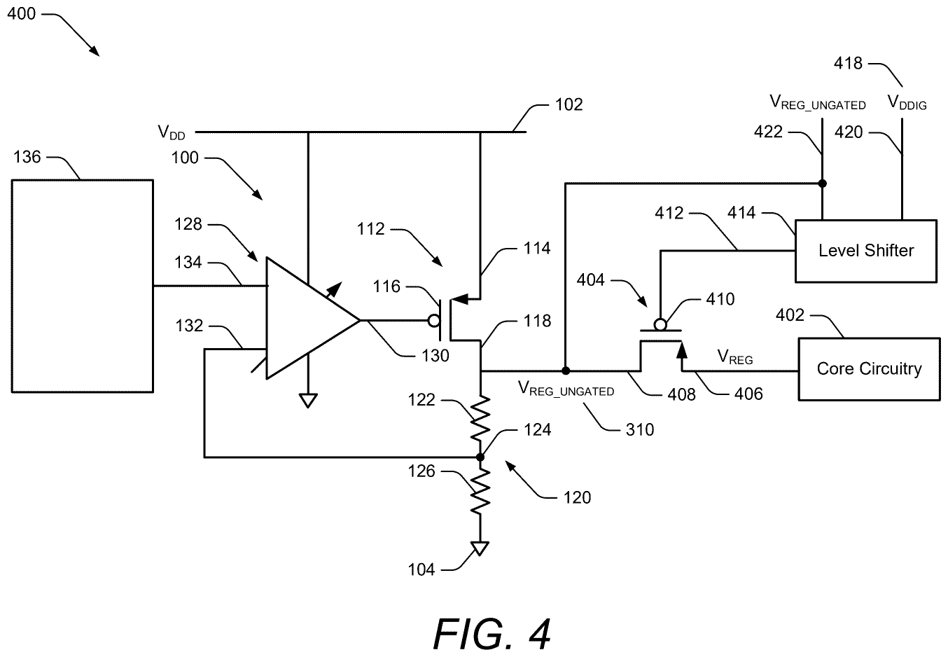

FIG. 4 shows a switched circuit 400 in which the regulator circuit 100 is coupled to the core circuitry 402 via a switch in the form of a transistor 404, which in this example includes a PMOS transistor. A source 406 of the transistor 404 is coupled to the core circuitry 402 and a drain 408 of the transistor 404 is coupled to the source 118 of the output transistor 112 that supplies V_{REG_UNGATED} 310. A gate 410 of the transistor 404 receives an output 412 of a level shifter 414 configured to translate signals into the logic domain of the ungated output V_{REG_UNGATED} 416 of the regulator circuit 100. The level shifter 414 receives V_{DDIG} 418 at a first input 420 and V_{REG_UNGATED} 416 at a second input 422. As a result, when the regulator circuit 100 is in the lower power state or is transitioning into the low-power state, the level shifter 414 applies a high output to the gate 410 of the transistor 404 to disable the transistor and isolate the regulator circuit 100 from other circuits to prevent current leakage.

### Operation of the Regulator

As previously described, the regulator circuit 100 is configured to switch between an active state when the regulator circuit 100 is powering core circuitry 110 and a low-power state when the regulator circuit 100 is not powering core circuitry 110 instead without the complexities and risks of powering the regulator circuit 100 on and off. Nonetheless, transitioning the regulator circuit 100 to a low-power state still results in significant current reductions to save power. In any case, it is important to maintain the stability of the regulator circuit 100 in both active and low power states.

One way to improve the stability of the regulator circuit 100 is to reduce the bandwidth at which the regulator circuit 100 operates. When operating at a low current level, stability is not a problem, but it will be appreciated that an object of the regulator circuit 100 is to provide what may amount to a considerable quantity of power to support the core circuitry 110. Accordingly, it may be a challenge to balance to how to provide a desired current level while maintaining stability. There are at least two ways to balance current level and stability. One is by maintaining a supportable ratio of maximum gain to minimum gain. A second way is to use Miller compensation in a regulator circuit.

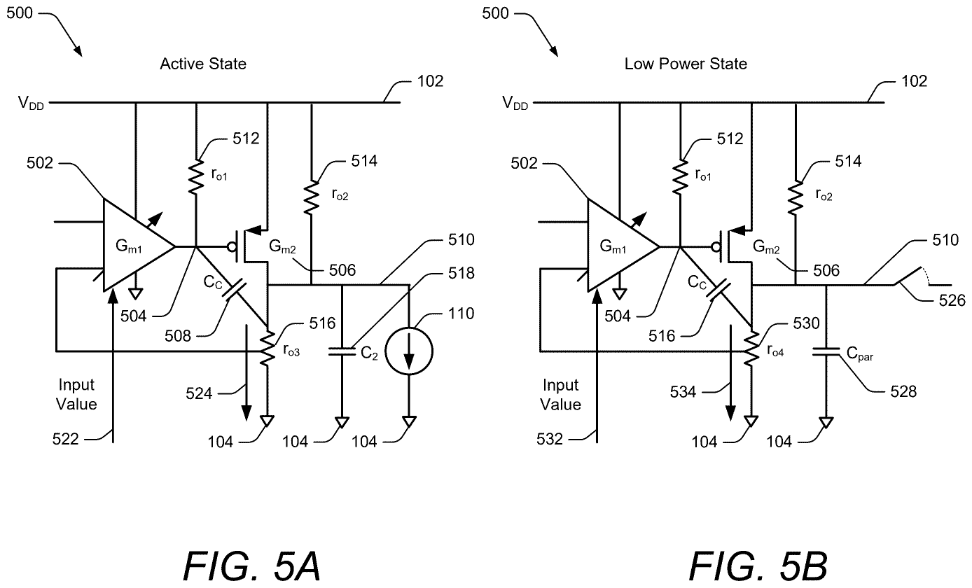

FIGS. 5A and 5B show a configuration of a regulator circuit 500 similar to the regulator circuit 100 of FIG. 1 but adapted to maintain stability while enabling a significant increase in current level from a low-power state to an active state. Referring to FIG. 5A, a regulator circuit 500 includes an amplifier with a transconductance Gₘ₁ 502, which represents a ratio of a circuit's capacity to change its output current relative to a change in its input voltage. An output 504 of the amplifier 502 is coupled to an output transistor with a transconductance Gₘ₂ 506. Middle compensation is used to stabilize the regulator circuit 500 by adding a capacitance C_{C} 508 between the output 504 of the amplifier 502 and an output 510 of the output transistor 506, where the output 510 of the output transistor 506 is at the source of the output transistor 506, as in the previous examples. Including middle compensation through the inclusion of the capacitance C_{C} 508 helps to restrict the bandwidth of the regulator circuit 500 to help maintain its stability in conjunction with other supporting circuitry. In the example of FIG. 5A, there is also a resistance of rₒ₁ 512 between V_{DD} 102 and the output 504 of the amplifier 502, a resistance rₒ₂ 514 between V_{DD} 102 and an output 510 of the output transistor 506, and a resistance rₒ₃ 516 between the output 510 of the output transistor 506 and V_{SS} 104. When in the active state, an additional capacitance C₂ 518 exists between the output 510 of the output transistor 506 and V_{SS} 104.

Balancing the objectives of providing a desired level of output current with maintaining stability, in aspects, the amplifier 502 is operated at a maximum gain that is many times higher than its input value 522. At this gain setting 522, the regulator circuit 500 is capable of generating an increased, active state current 524 at the output 510 of the output transistor 506 across the resistance rₒ₃ 518 when the regulator circuit 500 is operating in an active state, as shown in FIG. 5A.

Referring to FIG. 5B, the regulator circuit 500 exists in a low-power state that may exist before powering the core circuitry 110 (not shown in FIG. 5B; see FIG. 5A) or to which the regulator circuit transitions after powering the core circuitry 110 for some period. As previously described, when the core circuitry 110 is not powered, it may be desirable to use a switch 526, such as a transistor 404 (see FIG. 4) to isolate the regulator circuit 500 from the core circuitry 110 to reduce leakage currents, as depicted with the switch 526 in an open position. With the core circuitry 110 isolated from the regulator circuit 500, the capacitance C₂ 518 between the output 510 of the output transistor 506 and V_{SS} 104 becomes the circuit parasitic resistance, C_{PAR} 528. In addition, the resistance rₒ₃ 516 between the output 510 of the output transistor 506 and V_{SS} 104 is replaced with a much larger effective resistance rₒ₄ 530 on the order of one megaohm. In the low-power state, the gain of the amplifier 502 is reduced to a minimum gain equal to its input value 532. As a result, a low-power state current 534, many times less (e.g., potentially orders of magnitude less) than the high-bandwidth current 524 (see FIG. 5A), flows from the regulator circuit 500 across the resistance rₒ₄ 530 with the regulator circuit 500 operating in the low-power state, as shown in FIG. 5B.

In this configuration, the bandwidth of the regulator circuit 500 in the low-power state is three percent to seven percent of its bandwidth when in the active state. The configuration depicted in FIGS. 5A and 5B thus provides a balance in enabling the regulator circuit 500 to significantly increase its output current from the low-bandwidth current 534 (see FIG. 5B) to a high-bandwidth current while maintaining stability in both active and low-power states.

In a system in which mixed-signal power management is required to control input and output signals for a device, multiple regulator circuits may be deployed. For example, in a typical system, an analog-to-digital converter (ADC) and an analog front-end (AFE) may both be included and the operation of one can affect the operation of another. For example, an ADC typically performs a great deal of high-speed switching which can result in ripples in the supply current that potentially may affect other devices drawing power therefrom. Thus, it may be desired to provide separate sources of power for the ADC and the AFE, for which two regulator circuits will be provided. However, it will be appreciated that any number of regulator circuits may be used to power any number of systems or subsystems in a microprocessor, SoC, or other device.

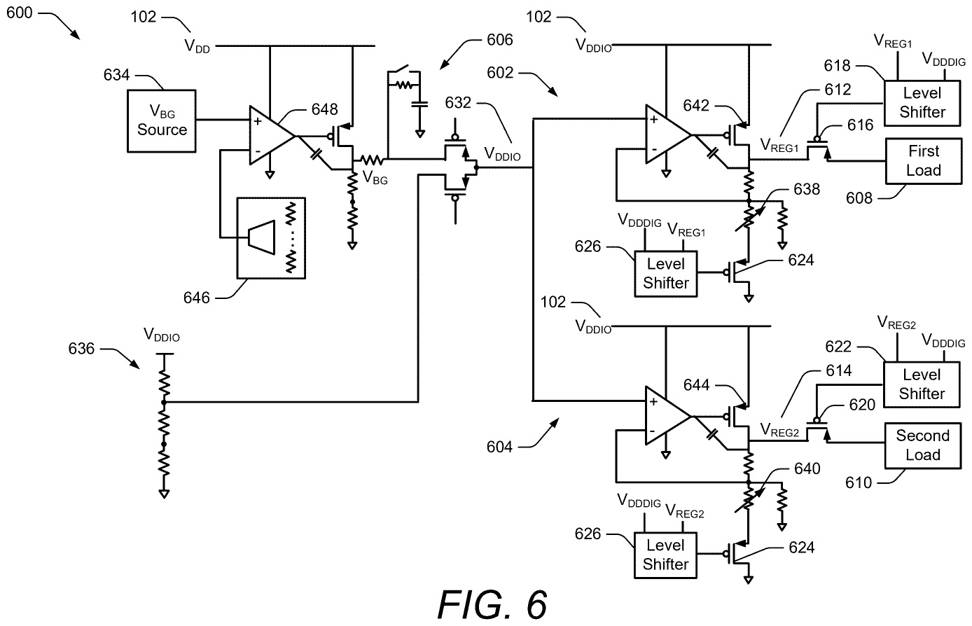

FIG. 6 shows an example system 600 that includes a first regulator circuit 600 and a second regulator circuit 602 which, in turn, receive power from a third regulator circuit 604. In the example system 600, the regulator circuit 602 may power a first load 608, such as an ADC while the regulator circuit 604 may power a second load 610, such as an AFE. The first regulator circuit 602 provides a source of V_{REG1} 612 for the first load 608 when the first load 608 is in operation. A first switch 616 in the form of a PMOS transistor controlled by a first level shifter 618 isolates the first regulator circuit 602 from the first load 608 when the first load 608 is not in operation to prevent current leakage and, thus, save power, as previously described. Correspondingly, a second switch 620 also in the form of a PMOS transistor controlled by a second level shifter 622 isolates the second regulator circuit 604 from the second load 610 when the second load 610 is not in operation to prevent current leakage and save power. In aspects, additional switches 624 and 626 controlled by additional level shifters 628 and 630 may isolate the regulator circuits 602 and 604 themselves, respectively, from V_{SS} 104 to further prevent leakage currents to save additional power.

Both the regulator circuits 602 and 604 draw power from V_{DDIO} 632 which itself may be sourced by the third regulator circuit 606. Similar to the device As previously described with reference to FIG. 3, the third regulator circuit 606 may receive power from a bandgap voltage (V_{BG}) source 634 and an always-on source 636. An output transistor 638 of the third regulator circuit 606 may selectively provide V_{BG} 640 to a multiplexer 642 to be selectively switched with an output of the always-on source 636 to provide V_{DDIO} 632 to power the regulator circuits 602 and 604. Thus, a number of regulator circuits may be provided in parallel or cascaded from one another to provide sources of regulated power to separate systems and subsystems in a device.

It will be appreciated that the regulator circuits 602, 604, and 606 may require trimming by adjusting the resistors coupled to the sources of output transistors. For example, the regulator circuits 602 and 604 may include adjustable resistors 638 and 640 between output transistors 642 and 644 of the regulator circuits 602 and 504, respectively. The regulator circuit 606 may also include a multiplexed circuit of resistors 646 coupled to the amplifier 648 to control the voltage output of the amplifier 648,

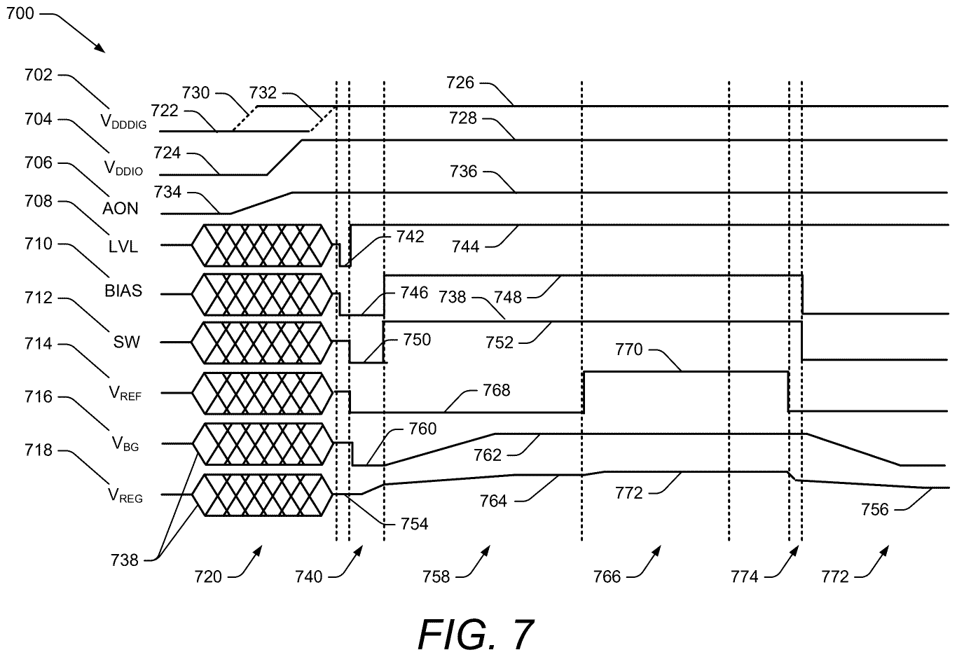

FIG. 7 shows a timing diagram 700 of a regulator circuit, such as that described with reference to FIGS. 1-7, in operation. As previously described in detail, external voltage sources, such as V_{DDDIG} 702 and V_{DDIO} 704 are provided to the regulator circuit. Internally, an always-on (AON) voltage 706 based on an external voltage, such as V_{DDIO} 704 as described with reference to FIG. 3, is provided internally within the regulator circuit. A level shifter input (LVL) 708 is applied to cause the regulator circuit to be coupled to a load. A bias signal 710 is generated by the amplifier 128 to activate an output transistor 112 of the regulator circuit (see FIG. 1). A switching signal to activate the regulator circuit (SW) 712. A voltage reference (V_{REF}) 714 and a precision bandgap voltage (V_{BG}) 716 are provided to the regulator circuit as described with reference to FIG. 3. A regulated voltage (V_{REG}) 718 is provided to power the load, as previously described.

During a startup interval 720, the external voltage sources V_{DDDIG} 702 and V_{DDIO} 704 are switched from respective low levels 722 and 724 to respective high levels 726 and 728. It is noted that V_{DDDIG} 702 includes dashed segments 730 and 732 because it is possible that V_{DDDIG} 702 may transition to its high level 726 before or after V_{DDIO} 704 transitions to a high level 728. AON 706, in response to the external voltage on which it relies switching to a high level, also transitions from a low level 734 to a high level 736

After a settling period 738 during which circuit voltages fluctuate subsequent to activation of a device, the timing diagram 700 shows how the regulator circuit responds to the provided voltages. During a first interval 740, LVL 708 transitions from a low level 742 to a high level 744 to direct the level shifter to couple the regulator circuit to the load. BIAS 710 transitions from a low level 746 to a high level 748 to enable the output transistor of the regulator device and SW 712 transitions from a low level 750 to a high level 752. In response to the changing inputs, V_{REG} 716 transitions from an initial voltage level 754 to its low-power state level 756.

During a next interval 758, the precision bandgap voltage source stabilizes and V_{BG} 716 transitions from its initial level 760 to its intended output level 762. V_{REG} 718, with the regulator circuit transitioning from being sourced by the always-on source to the precision voltage source, as described with reference to FIG. 3, and transitions to its active voltage 764, V_{SAFE}. During a next interval 766, the V_{REF} 714 transitions from an always-on source level 768 to a precision source level 770. As a result, V_{REG} 718 stabilizes at a precision active level of V_{SAFE} 772. During a net interval, SW 712 transitions to the low level 750. As a result, BIAS 710 transitions to the low level 746 and V_{BG} 716 transitions the low level 762. As a result, V_{REG} 718 resumes its low-power state level 756. Thus, after responding to inputs to provide V_{REG} 718 to power the load at an and then stabilizing at V_{SAFE}, the regulator circuit is transitioned to a low-power state to conserve power without completely being shut off.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

### CONCLUSION

Although implementations of systems and techniques for a no power-off voltage regulator for small-scale low-voltage system have been described in language specific to certain features and/or methods, the subject of the appended claims is not necessarily limited to the specific features or methods described. Rather, the specific features and methods are disclosed as example implementations of systems and techniques for a no power-off voltage regulator for small-scale low-voltage system.

What is claimed is:

1. A regulator circuit apparatus comprising:
a single output transistor configured to supply power to core circuitry:
in an active state at an operating voltage within a safe operating range for core circuitry; and
in a low-power state at a low voltage below the operating voltage without shutting down the single output transistor; and
an amplifier configured to selectively supply a bias voltage to the single output transistor effective to cause the single output transistor to:
supply the operating voltage when the single output transistor is in the active state; and
supply the low power voltage when the single output transistor is in the low-power state.

2. The regulator circuit apparatus of claim 1, further comprising:
a current source configured to switchably bias the amplifier and to provide current to power the core circuitry, the current source including:
a current mirror configured to provide operating current to the amplifier when the current mirror is in a stable operating condition;
a startup circuit configured to direct supplemental current to the current mirror to drive the current mirror into the stable operating condition; and
a biasing circuit configured to stop the startup circuit from directing the supplemental current to the current mirror when the current mirror is in the stable operating condition.

3. The regulator circuit apparatus of claim 1, further comprising:
a switchable reference voltage including;
an always-on source configured to provide an approximation of the reference voltage from an input voltage;
a precision voltage source configured to provide the reference voltage after an interval; and
a switch configured to provide a reference voltage source configured to provide the approximation of the reference voltage source during the interval and transition to the reference voltage at the end of the interval.

4. The regulator circuit apparatus of claim 3, wherein the always-on source includes a voltage divider to generate the approximation of the reference voltage from the input voltage.

5. The regulator circuit apparatus of claim 3, wherein the switch includes a multiplexer that is switched by an overlapping clock generator to ensure that at least one of the approximation of the reference voltage or the reference voltage is provided at the reference voltage source.

6. The regulator circuit apparatus of claim 5, wherein the always-on voltage source and the precision voltage source each include at least one resistor to resist backward-flowing currents that may be generated when more than one of the approximation of the reference voltage or the reference voltage is provided at the reference voltage source.

7. The regulator circuit apparatus of claim 1, further comprising a switch to isolate the regulator circuit from the core circuitry when the regulator circuit is in the low-power state.

8. The regulator circuit apparatus of claim 7, wherein the switch includes a switching transistor controlled by a level shifter responsive to an output voltage of the regulator circuit, the level shifter disabling the switching transistor when the output voltage of the regulator indicates the regulator circuit is in the low-power state.

9. The regulator circuit apparatus of claim 1, wherein the regulator circuit includes a capacitance to apply middle compensation between an output of the amplifier and the output of the single output transistor to limit the bandwidth of the regulator circuit.

10. The regulator circuit apparatus of claim 1, further comprising a plurality of regulator circuits configured to provide separate supply powers each with operating voltages within the safe operating range for separate loads of core circuitry.
